(19) United States
(12) Patent Application Publication
(10) Pub. No.: US 2020/0308490 A1
(43) Pub. Date: Oct. 1, 2020

(54) PHOSPHORUS FLAME RETARDANT AND METHOD OF PRODUCING PHOSPHINYL CARBOXYLIC ACID ESTER MIXTURES

(71) Applicant: Far Eastern New Century Corporation, TAIPEI (TW)

(72) Inventors: Yi-Hsuan Chang, TAIPEI (TW); Hsiang-Chin Tsai, TAIPEI (TW)

(21) Appl. No.: 16/540,075

(22) Filed: Aug. 14, 2019

(30) Foreign Application Priority Data
Mar. 28, 2019 (TW) 108110833

(51) Int. Cl. C09K 21/12

(52) U.S. Cl. CPC C09K 21/12

(57) ABSTRACT

A method of producing a phosphinyl carboxylic ester is provided. First a phosphinyl carboxylic acid is provided, then a diol is added to the phosphinyl carboxylic acid. Later, the phosphinyl carboxylic acid undergoes a condensation reaction with the diol in the presence of a basic compound to obtain a phosphinyl carboxylic ester mixture. The phosphinyl carboxylic ester mixture includes a phosphinyl monoester and a phosphinyl diester.

### BACKGROUND OF THE INVENTION

### 1. Field of the Invention

The present invention relates to a method of producing a phosphinyl carboxylic ester mixture, and to a phosphorus flame retardant. In particular, the present invention is directed to a method for producing a phosphinyl carboxylic ester mixture by the addition of a base compound for the promotion of a condensation reaction of a diol with a phosphinyl carboxylic acid, and to a phosphorus flame retardant in the presence of a trace amount of a base salt.

### 2. Description of the Prior Art

A phosphorus flame retardant, such as a reactive or a copolymerized phosphorus flame retardant, is suitable for use in the flame retardant modification of polymer materials because it is an environmentally friendly flame retardant, so it is widely used in various flame retardant fields. For example, 3-hydroxyphenyl phosphinyl propionic acid is a common environmentally friendly flame retardant.

However, since 3-hydroxyphenylphosphinyl propionic acid has poor thermal stability, a method for increasing the thermal stability of 3-hydroxyphenylphosphinyl propionic acid is still needed. For example, the reference “Flame Retardant Polyesters, I, Phosphorous [Journal of Applied Polyester Science, Vol. 106, 2870-2874 (2007)]” discloses the modification of 3-hydroxyphenylphosphinyl propionic acid to improve its thermal stability. The reference mentions that the reaction temperature for the modification is 100° C. to successfully modify 3-hydroxyphenylphosphinyl propionic acid to yield 3-hydroxyphenylphosphinyl propionic acid ester, but the reaction time is longer than 50 hours. As a result, it is not only energy-consuming, but also the reaction time is too long, so this is not an advantageous method for use in the industrial mass production. Furthermore, if the method disclosed in the reference is used, there may be certain amount of residues (by-products) present, and the residues may interfere with the subsequent application of the flame retardant.

Therefore, it is still needed to propose a novel method which provides a novel process suitable for the modification of 3-hydroxyphenylphosphinyl propionic acid. The novel method not only requires very short reaction time, but also has a high yield and the amount of the residues is controlled to be less than 1% by weight, so it is an advantageous method suitable for energy-saving in industrial mass production.

### SUMMARY OF THE INVENTION

In view of the above, the present invention accordingly proposes a method for producing a phosphinyl carboxylic ester mixture, and a phosphorus flame retardant. The phosphinyl carboxylic ester mixture which is produced by the method of the present invention includes a minor amount of phosphinyl mono-ester condensate and a major amount of phosphinyl di-ester condensate. In addition, the method for producing a phosphinyl carboxylic ester mixture of the present invention not only produces a phosphinyl carboxylic ester mixture of high thermal stability, but also is very energy-saving, so it only takes very short reaction time and consumes extremely small energy to have a high yield. It is indeed an advantageous method for use in the industrial mass production.

According to one embodiment of the present invention, the present invention first proposes a method for producing a phosphinyl carboxylic ester mixture. The method includes at least the following steps:

(1) providing a phosphinyl carboxylic acid;
(2) adding a diol to the phosphinyl carboxylic acid;
(3) performing a condensation reaction of the diol with the phosphinyl carboxylic acid in the presence of a basic compound to obtain a phosphinyl carboxylic ester mixture. The phosphinyl carboxylic ester mixture includes a phosphinyl monoester condensate and a phosphinyl diester condensate.

According to the above embodiment of the present invention, the weight of the basic compound is 100 ppm to 10000 ppm based on the total weight of the phosphinyl carboxylic acid and the diol.

According to the above embodiment of the present invention, the weight of the diol is 40%-60% of the total weight of the phosphinyl carboxylic acid and the diol.

According to the above embodiment of the present invention, the weight of the phosphinyl carboxylic acid is 60%-40% of the total weight of the phosphinyl carboxylic acid and the diol.

According to another embodiment of the present invention, the present invention further provides a phosphorus flame retardant which is obtained by the above-described method for producing a phosphinyl carboxylic ester mixture. The phosphorus flame retardant which is obtained by the method for producing the phosphinyl carboxylic ester mixture of the present invention includes at least:

(1) 10 wt. %-20 wt. % of a phosphinyl monoester, based on the total weight of the phosphorus flame retardant;
(2) 80 wt. %-90 wt. % of a phosphinyl diester, based on the total weight of the phosphorus flame retardant;
(3) less than 1 wt. % of a residue, based on the total weight of the phosphorus flame retardant; and
(4) 0.01 wt. %-1 wt. % of a basic compound, based on the total weight of the phosphorus flame retardant.

According to the above embodiments, a method for producing a phosphinyl carboxylic ester mixture as well as a phosphorus flame retardant obtained by the method are provided. An alkali compound is ingeniously introduced into the method for producing a phosphinyl carboxylic ester mixture to promote the esterification reaction and the dehydration reaction of the phosphinyl carboxylic acid with the diol compound to reduce the reaction time so as to obtain a phosphinyl carboxylic ester mixture which includes a minor amount of phosphinyl monoester and a major amount of phosphinyl diester.

Because the alkali compound is ingeniously introduced into the method for producing a phosphinyl carboxylic ester mixture to respectively promote the esterification reaction and the dehydration reaction, the yield of the phosphinyl carboxylic ester mixture is especially high. Preferably speaking, the content of the phosphinyl diester condensate in the phosphinyl carboxylic ester mixture may be 80% or more based the total weight, and the content of the phosphinyl monoester condensate in the phosphinyl carboxylic ester mixture may be 20% or less based the total weight.

Compared with the conventional modification method for producing a phosphorus-based flame retardant, the method for producing a phosphinyl carboxylic ester mixture of the present invention is very energy-saving because an alkali compound is used as a promoting agent so it takes only a little time to obtain a high yield to be an advantageous method which is suitable for use in the industrial mass production.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

N/A

### DETAILED DESCRIPTION

In the following paragraphs, in order to describe a specific range of values, the expression ‘a value to another value’ is used, and it should be interpreted as covering any numerical value within the range of values and a smaller range defined by any numerical value within the numerical range as the written values and the smaller numerical range recited in the specification. In addition, for the sake of simplicity and brevity, some structures of the respective polymers or moieties hereinafter are sometimes represented by a ‘skeleton formula’ to omit the carbon atoms, hydrogen atoms and carbon-hydrogen bonds within the actual structure. However, where a specific atom or a moiety is explicitly shown in a structural formula, the structural formula should be taken as a reference.

According to a first embodiment of the present invention, a method for producing a phosphinyl carboxylic ester mixture is provided. The method includes at least the following steps:

(1) providing a phosphinyl carboxylic acid;
(2) adding a diol to the phosphinyl carboxylic acid; and
(3) performing a condensation reaction of the diol with the phosphinyl carboxylic acid in the presence of a basic compound to obtain a phosphinyl condensate of the phosphinyl carboxylic acid modified with a diol. The phosphinyl condensate includes a mixture of phosphinyl carboxylic esters of a phosphinyl monoester condensate and a phosphinyl diester condensate.

As described above, first a phosphinyl carboxylic acid is provided. The phosphinyl carboxylic acid may have a phosphinyl carboxylic structure represented by the general formula (I), wherein X may be an alkylene group, Y may be an alkyl substituent or an aryl substituent. For example, the substituent X or Y which is directly bonded to the single phosphorus atom in the phosphinyl carboxylic acid molecule may be an ethylene group for X, or a substituent which is selected from a group consisting of a methyl group and a phenyl group for Y.

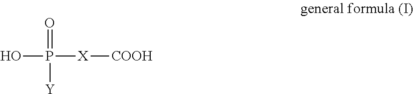

Preferably, Y may be a phenyl group. Therefore, in a preferred embodiment the above phosphinyl carboxylic acid may be 3-hydroxyphenylphosphinyl propionic acid represented by the formula (1).

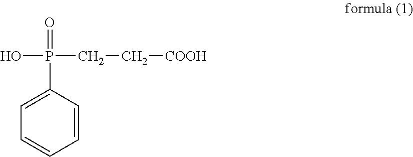 [SMILES: O=C(O)CCP(=O)(O)c1ccccc1]

Then, a diol compound of the following general formula (II) is added to the aforementioned phosphinyl carboxylic acid. Z in the general formula (II) may be an alkylene group, for example an ethylene group or a propylene group. The diol compound refers to a saturated hydrocarbon with two hydroxyl groups, for example ethylene glycol or propylene glycol.

HO—Z—OH general formula (II)

The diol compound may preferably have the following features: good chemical reactivity with the reactant phosphinyl carboxylic acid. For example, it may respectively react with the carboxylic acid group (—COOH) and with the hydroxyl group (—POH) in the phosphinyl carboxylic acid to respectively undergo an esterification reaction and a dehydration reaction, to further increase the thermal stability of the phosphinyl carboxylic acid structure. The diol compound is selected from a linear diol compound, for example, at least one of ethylene glycol and propylene glycol, but the present invention is not limited to these. Preferably speaking, the diol compound may be ethylene glycol.

The amount of the diol compound and the aforementioned phosphinyl carboxylic acid may be as follows. The amount of the diol compound may be in a range from 40% to 60% by weight based on the total weight of the diol compound and the phosphinyl carboxylic acid. The amount of the phosphinyl carboxylic acid may be in a range from 60% to 40% by weight based on the total weight of the diol compound and the phosphinyl carboxylic acid. Preferably, an excess of the diol compound may be used. For example, the weight ratio of the diol to the phosphinyl carboxylic acid may be 55:45.

Further, in the presence of a basic compound, the diol is subjected to a condensation reaction with the phosphinyl carboxylic acid to obtain a phosphinyl condensate of the phosphinyl carboxylic acid which is modified with the diol. Preferably speaking, both the carboxylic group and the hydroxyl group in the phosphinyl carboxylic acid molecule react with the hydroxyl groups in the diol compound to be modified by the diol so as to remarkably increase the thermal stability of the resultant phosphinyl carboxylic acid ester.

The above basic compound may be an organic base or an inorganic base. The weight of the basic compound added to the mixture of the diol and the phosphinyl carboxylic acid may be in a range from 100 ppm to 10,000 ppm of the total weight of the diol and the phosphinyl carboxylic acid. To facilitate the addition to and the uniform mixing with the mixture of the diol and the phosphinyl carboxylic acid, the basic compound may be formulated in a form of an aqueous solution. For example, the basic compound may be formulated in a form of a 20% aqueous solution.

A suitable organic base may be a nitrogen-containing base, for example, may be a nitrogen-containing weak base, a nitrogen-containing heterocyclic base, or a tertiary ammonium base which is substituted with at least one of an aromatic group, a linear alkyl group or a branched alkyl group. For example, the organic base may be a nitrogen-containing base such as tetramethylammonium hydroxide, tetraethylammonium hydroxide or the like. For instance, tetraethylammonium hydroxide may be may be formulated in a form of a 20% aqueous solution to be added to a mixture of the diol and the phosphinyl carboxylic acid. An aqueous solution which is prepared by the addition of the organic base may have a pH value of about 14, i.e. a basic solution. The salt of the basic compound may be a tetramethylammonium hydroxide salt or a tetraethylammonium hydroxide salt.

The inorganic base may be an inorganic metal alkaline compound, for example, an inorganic metal alkaline compound of the alkali metal group. For instance, the inorganic metal alkaline compound may be potassium hydroxide. The salt of the inorganic metal alkaline compound may be a potassium salt.

The inventor found that when a basic compound is added to a mixture of a diol and a phosphinyl carboxylic acid, the basic compound greatly promotes the esterification reaction and the dehydration reaction between the diol and the phosphinyl carboxylic acid. Therefore, the basic compound which serves as a promoter is able to not only significantly reduce the reaction time of the diol with the phosphinyl carboxylic acid, but also significantly increase the yield of the phosphinyl carboxylic ester mixture. The addition of a basic compound to a mixture of a diol and a phosphinyl carboxylic acid indeed achieves multiple advantageous effects. This is one feature of the method for producing a phosphinyl carboxylic ester mixture of the present invention.

The above condensation reaction may be an esterification reaction and a dehydration reaction. Because both the carboxyl group and the hydroxyl group are present in the phosphinyl carboxylic acid molecule, the hydroxyl groups of the diol can respectively undergo an esterification reaction with the carboxyl group, and a dehydration reaction with the hydroxyl group. The phosphinyl condensate obtained by the reactions includes a mixture of a phosphinyl carboxylic esters which includes a phosphinyl monoester condensate and a phosphinyl diester condensate. For example, the following general formula (III) represents a phosphinyl monoester condensate.

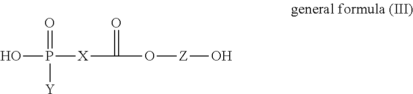

The X, Y and Z in the general formula (III) may be the substituents as described above.

The phosphinyl diester condensate is represented by the following general formula (IV).

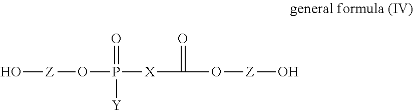

The X, Y and Z in the general formula (IV) may be the substituents as described above.

The reaction temperature of the above condensation reaction may be stepwisely raised. For example, after the addition of the basic compound to the mixture of the diol and the phosphinyl carboxylic acid, the basic compound, the mixture of the diol, the phosphinyl carboxylic acid and the basic compound may be heated from room temperature to a first temperature. The first temperature may be in a range from 80° C. to 100° C., preferably 85° C.

When the mixture solution is heated to the first temperature, the phosphinyl carboxylic acid may be completely dissolved in the solution mixture by well stirring to form a homogeneous solution. The mixture solution at the first temperature may have a homogeneous acid value. Since the condensation reaction has yet to start when the temperature of the mixture solution is raised to the first temperature, the homogeneous acid value of the solution mixture at this time is the initial acid value (that is, the maximal acid value). For example, the initial acid value of the solution mixture exceeds 500 mg of potassium hydroxide/gram.

Then, the solution mixture is further heated to a second temperature. The second temperature may be in a range from 150° C. to 170° C., preferably 160° C. When the temperature reaches the second temperature, the condensation polymerization reaction starts, and the acid value starts to drop.

When the acid value of the solution mixture drops to 200 mg potassium hydroxide/gram, a first reaction acid value, the temperature may be further raised to a third temperature. According to an embodiment of the present invention, for example, the condensation reaction may be carried out at a third temperature in a range from 160° C. to 175° C., preferably about 175° C. When the acid value of the phosphinyl condensate is as low as 70-80 mg of potassium hydroxide/gram, a second reaction acid value, the condensation reaction is stopped.

After the solution mixture is cooled down to room temperature, a mixture of phosphinyl carboxylic ester of completed condensation reaction can be obtained.

Specifically speaking, in the method for producing a phosphinyl carboxylic ester mixture of the present invention, from the addition of a basic compound to a mixture of a diol and a phosphinyl carboxylic acid to the raise to the third temperature, for example, about 175° C., it takes about only 90 minutes reaction time in total for the solution mixture. Compared with the prior art which requires the reaction time of 50 hours or more, the method for producing the phosphinyl carboxylic ester mixture of the present invention not only greatly reduces the reaction time, but also greatly reduces the energy consumption to significantly decrease the thermal budget of the reaction process so this is indeed an advantageous method for industrial mass production.

As described above, the reaction process stays in the same reaction system from the addition of the basic compound to the solution mixture of the diol and the phosphinyl carboxylic acid to the stop of heating when the acid value of the solution mixture drops to the second reaction acid value. The steps such as separation, purification, crystallization and extraction . . . etc. are not needed during the condensation reaction period so this is a typical one pot reaction. A one-pot reaction is advantageous for the simplification of the process and the reduction of the reaction time. This is one of the features of the method for producing a phosphinyl carboxylic ester mixture of the present invention.

The phosphinyl carboxylic ester mixture of the present invention may serve as a phosphorus flame retardant. The phosphinyl carboxylic ester mixture of the present invention includes a major amount of a phosphinyl diester condensate represented by the general formula (IV), a minor amount of a phosphinyl monoester condensate represented by the general formula (III), a residue represented by the general formula (V), and a salt of a basic compound. The X, Y and Z in the general formulae may be the substituents as described above.

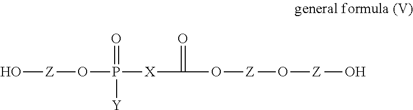

Preferably speaking, in the phosphinyl carboxylic ester mixture of the present invention, the content of the phosphinyl diester condensate is more than 80% by weight, the content of the phosphinyl monoester condensate is less than 20% by weight, and the content of the residue is less than 1% by weight. The content of the basic compound is in a range from 0.01% to 1% by weight, all based on the total weight of the phosphinyl carboxylic ester mixture. As a result, another feature of the method resides in that a high content of the phosphinyl diester condensate, a low content of the phosphinyl monoester condensate and a small amount of the residue may be obtained without the need of separation, purification or extraction. Specifically speaking, the content of the phosphinyl monoester condensate in the phosphorus flame retardant of the present invention may be less than 20% by weight.

In one embodiment of the present invention, when ethylene glycol and 3-hydroxyphenylphosphinyl propionic acid are used for the production of the phosphinyl carboxylic ester mixture of the present invention, the obtained phosphorus flame retardant mainly includes a major amount of a phosphinyl diester condensate represented by the formula (3), a minor amount of a phosphinyl monoester condensate represented by the formula (2), a residue represented by the formula (4), and a salt of a basic compound.

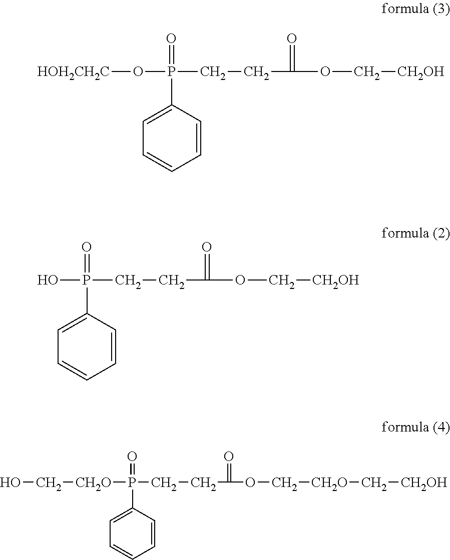

One of the features of the phosphinyl carboxylic ester mixture for use as a phosphorus flame retardant of the present invention resides in that the phosphinyl carboxylic ester mixture particularly includes a basic compound. Specifically speaking, the amount of the basic compound is in a range between 0.01% by weight and 1% by weight, based on the total weight of the phosphinyl carboxylic ester mixture.

According to another embodiment of the present invention, the reactants and the products in the phosphinyl carboxylic ester mixture obtained by the method for producing a phosphinyl carboxylic ester mixture of the present invention may have characteristic equivalent ratios as follows, for example:

(residue/phosphinyl diester condensate)=0.45%;
(phosphinyl diester condensate/phosphinyl carboxylic acid)=88.6%;
(phosphinyl monoester condensate/phosphinyl carboxylic acid)=10.9%;
(phosphinyl monoester condensate/phosphinyl diester condensate)=12.3%.

Embodiments of the present invention are given as follows to further describe the present invention in detail in order to enable those of ordinary skill in the art to practice the present invention. It is noted that the following embodiments are given here for the illustrative purpose only and should not be construed as the limitations of the scope of the present invention. That is, the materials or the like used in the respective embodiments can be appropriately modified without departing from the scope of the invention.

The following is a list of abbreviations of each compound in the following examples and comparative examples and its source information:

Starting material: 3-Hydroxyphenylphosphinyl propionic acid, purchased from AUSPRING CO., LTD.
Ethylene glycol: purchased from Sigma-Aldrich.
Tetraethylammonium hydroxide: purchased from Sigma-Aldrich.
Potassium hydroxide: purchased from Sigma-Aldrich.

### Embodiment

Reactant 3-(Hydroxyphenylphosphinyl) propionic acid, CAS No. 14657-64-8, addition ratio: 42% by weight, based on the total weight.

Reactant ethylene glycol, CAS No. 107-21-1, addition ratio: 58% by weight, based on the total weight.

Reactant tetraethylammonium hydroxide, CAS No. 77-98-5, addition ratio: 0.1% by weight, based on the total weight.

### Example 1

330 g of 3-hydroxyphenylphosphinyl propionic acid, 460 g of ethylene glycol and tetraethylammonium hydroxide of 0.79 g 20% aqueous solution are added to a flask of 1000 ml with a rectification unit. 3-hydroxyphenylphosphinyl propionic acid gradually dissolves to form a homogeneous mixture solution when heated oil bath is used to raise the temperature to about 80° C. to initiate the magnetic stirring. The reaction runs for 30 minutes when the internal temperature reaches 160° C. Then, the temperature is raised to 175° C. to run the reaction for another 30 minutes when the internal temperature reaches 175° C. The heat source is removed to leave the system cools down after the reaction is completed.

The initial acid value before the reaction: 522.4 mg potassium hydroxide/gram, the homogeneous acid value: 522.4 mg potassium hydroxide/gram, the first reaction acid value after the reaction: 219 mg potassium hydroxide/gram, and the second reaction acid value after the reaction: 75.13 mg potassium hydroxide/gram.

### Example 2

1000 kg of 3-hydroxyphenylphosphinyl propionic acid, 1380 kg of ethylene glycol and tetraethylammonium hydroxide of 2.38 kg 20% aqueous solution are added to a reactor of 2.5 metric tons with a rectification unit. 3-hydroxyphenylphosphinyl propionic acid gradually dissolves to form a homogeneous mixture solution when the temperature rises to about 80° C. to initiate the magnetic stirring. The reaction runs for 30 minutes when the internal temperature reaches 160° C. Then, the temperature is raised to 175° C. to run the reaction for another 30 minutes when the internal temperature reaches 175° C. The heat source is removed to leave the system cools down after the reaction is completed.

The initial acid value before the reaction: 522±5 mg potassium hydroxide/gram, and the second reaction acid value after the reaction: 75 mg of potassium hydroxide/gram.

### Example 3

Test of Acid Value of Phosphinyl Carboxylic Ester Mixture Before and after the Reaction

Acid Value Test

Equipment used: 25 ml burette, 3*250 ml Erlenmeyer flasks, 50 ml graduated cylinder

Reagents: 0.1 mol/L potassium hydroxide standard solution, 0.2% phenolphthalein ethanol solution as the indicator, 95% ethanol solution

Operation Method

weighted 0.25 g of the phosphinyl carboxylic ester mixture solution (standard to 0.0002 g) is in an Erlenmeyer flask with the addition of 40 ml ethanol solution, and stirred to dissolve uniformly. 2-3 drops of the indicator are added and the solution is titrates with 0.1 mol/L potassium hydroxide standard solution. When the titration solution turns into pink and maintains for 30 seconds without fading, the acid value of the phosphinyl carboxylic ester mixture solution is determined by the end point of the titration.

2. A Blank Test is Performed with the Same Method.

### 3. Calculation of the Acid Value

The acid values of the phosphinyl carboxylic ester mixture solution are calculated in accordance with the following formula:

Acid value (mg potassium hydroxide/gram)=(V1−V0)*C*56.1/m

V1=volume (ml) of the potassium hydroxide standard solution to reach the end point of the titration of the phosphinyl carboxylic ester mixture solution to be tested;
V0=volume (ml) of the potassium hydroxide standard solution used at the end of the titration for the blank test;
C=concentration of potassium hydroxide standard solution (0.1 mol/liter);
56.1=molecular weight of the reactant potassium hydroxide;
m=the weight of the phosphinyl carboxylic ester mixture solution to be tested.

After test, the initial acid value of 3-hydroxyphenylphosphinyl propionic acid which has not undergone the condensation reaction is 522±5 mg potassium hydroxide/g, and the second reaction acid value of the phosphinyl carboxylic ester mixture after the condensation reaction is completed is about 70 mg potassium hydroxide/gram-80 mg of potassium hydroxide/gram.

### Example 4

Test of the Composition of the Phosphinyl Carboxylic Ester Mixture

The above-mentioned phosphinyl carboxylic ester mixture includes a major amount of a phosphinyl diester condensate represented by the formula (3), a minor amount of a phosphinyl monoester condensate represented by the formula (2), a small amount of the residue represented by the formula (4), and a salt of a basic compound. The above-mentioned phosphinyl carboxylic ester mixture can be further subjected to high performance liquid chromatography (HPLC), for example with the HPLC column HP-5 of 150*4.5 mm*5 μm at 25° C. in the presence of a mobile phase CH₃CN 0.1% H₃PO₄/H₂O, to determine the ratio of the phosphinyl diester condensate, the phosphinyl monoester condensate and the residue in the phosphinyl carboxylic ester mixture for analysis.

After HPLC analysis, in the phosphinyl carboxylic ester mixture, it is confirmed that the phosphinyl monoester condensate is 10.9% by weight, the phosphinyl diester condensate is 88.6% by weight, and the residue is 0.4% by weight, all of which are based on the total weight of the phosphorus flame retardant.

In other words, in the method for producing a phosphinyl carboxylic ester mixture of the present invention, each ingredient can also be converted into the following equivalent ratio:

(residue/phosphinyl diester condensate)=0.45%;
(phosphinyl diester condensate/phosphinyl carboxylic acid)=88.6%;
(phosphinyl monoester condensate/phosphinyl carboxylic acid)=10.9%;
(phosphinyl monoester condensate/phosphinyl diester condensate)=12.3%.

### Comparative Example

The reaction is carried out in a reactor of 2.5 metric tons with a rectification unit at 100° C. for 50 hours in accordance with the suggested reaction conditions in prior art. The novel method for producing a phosphinyl carboxylic ester mixture of the present invention is carried out at 175° C. for 90 minutes. The energy consumption of the two reaction processes is listed below. The energy needed in the suggested reaction conditions in prior art is determined to be about 4238 million calories. The energy needed in the novel method for producing a phosphinyl carboxylic ester mixture of the present invention is about 358 million calories.

As a result, the energy consumption of the novel method for producing a phosphinyl carboxylic ester mixture of the present invention is only approximately 1/11.84 of the suggested reaction conditions in prior art, i.e., reduced to about 8.45%, compared to the energy required for prior art. In other words, the novel method for producing a phosphinyl carboxylic ester mixture of the present invention reduces the energy consumption to be as low as 1/11.84, which shows a green process to be energy-saving and environmentally friendly.

Comparison table

| | Comparative | |
|---|---|---|
| | Example | Example 2 |
| Reaction time (hours) | 50 | 1.5 |
| Reaction temperature (° C.) | 100 | 175 |
| Total energy consumption | 4238 | 358 |
| (million calories) | | |
| Energy consumption ratio | 11.84 | 1 |
| Yield | 50% | 86% |

In summary, the present invention is capable of providing a method for producing a phosphinyl carboxylic ester mixture. The method of the present invention, suitable for the excellent reaction conditions of one-pot reaction, simultaneously promotes the condensation reaction of the esterification reaction and of the dehydration reaction by the addition of a weak base, thereby obtaining a phosphinyl carboxylic ester mixture which includes a major amount of a phosphinyl diester condensate, a minor amount of a phosphinyl monoester condensate, a small amount of a salt of a basic compound for use as a promoter and a residue.

The phosphinyl carboxylic ester mixture which includes a major amount of a phosphinyl diester condensate is advantageous for use as a phosphorus flame retardant, and is characterized in that it has a small amount of a salt of a basic compound. In addition, compared with prior art, the method for producing a phosphinyl carboxylic ester mixture of the present invention not only consumes far less energy, but also requires much less reaction time, which are features of the method for producing a phosphinyl carboxylic ester mixture of the present invention as well.

For example, a small amount of the phosphinyl monoester condensate may be less than 20% by weight, a major amount of a phosphinyl diester condensate is preferably more than 80% by weight, and a trace amount of a basic compound is in a range from 0.01% by weight to 1% by weight, and the residue is less than 1% by weight.

The novel method of the present invention can produce an environmentally-friendly phosphorus flame retardant which has a major amount of a phosphinyl diester condensate. The method for producing a phosphinyl carboxylic ester mixture of the present invention not only requires very short reaction time, but also has a high yield without the need of traditional processing steps such as separation, purification, crystallization or extraction so it is indeed an advantageous method which is suitable for use in industrial mass production.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of producing a phosphinyl carboxylic ester mixture, comprising:
providing a phosphinyl carboxylic acid;
adding a diol to the phosphinyl carboxylic acid; and
performing a condensation reaction of the phosphinyl carboxylic acid with the diol in the presence of a basic compound to obtain a phosphinyl condensate which is a condensed phosphinyl product of the phosphinyl carboxylic acid modified with the diol, wherein the condensed phosphinyl product is a phosphinyl carboxylic ester mixture comprising a phosphinyl monoester condensate and a phosphinyl diester condensate.

2. The method of producing a phosphinyl carboxylic ester mixture of claim 1, wherein the condensation reaction is performed under a temperature of 160° C.-175° C.

3. The method of producing a phosphinyl carboxylic ester mixture of claim 1, wherein the diol is selected from a group consisting of ethylene glycol and propylene glycol.

4. The method of producing a phosphinyl carboxylic ester mixture of claim 1, wherein the condensation reaction is stopped when an acid value of the condensed phosphinyl product is reduced to 70 mg-80 mg potassium hydroxide/g.

5. The method of producing a phosphinyl carboxylic ester mixture of claim 1, wherein the phosphorus atom in the phosphinyl carboxylic acid has a substituent selected from a group consisting of methyl group and phenyl group.

6. The method of producing a phosphinyl carboxylic ester mixture of claim 1, wherein the basic compound is an organic base.

7. The method of producing a phosphinyl carboxylic ester mixture of claim 6, wherein the organic base is a nitrogen-containing base.

8. The method of producing a phosphinyl carboxylic ester mixture of claim 7, wherein the nitrogen-containing base has a substituent selected from a group consisting of an aromatic group, a linear alkyl group and a branched alkyl group.

9. The method of producing a phosphinyl carboxylic ester mixture of claim 1, wherein the basic compound is an inorganic base.

10. The method of producing a phosphinyl carboxylic ester mixture of claim 1, wherein the weight of the basic compound is 100 ppm-10000 ppm of the total weight of the phosphinyl carboxylic acid and the diol.

11. The method of producing a phosphinyl carboxylic ester mixture of claim 1, wherein the weight of the diol is 40%-60% of the total weight of the phosphinyl carboxylic acid and the diol.

12. The method of producing a phosphinyl carboxylic ester mixture of claim 1, wherein the weight of the phosphinyl carboxylic acid is 60%-40% of the total weight of the phosphinyl carboxylic acid and the diol.

13. A phosphorus flame retardant, comprising:
10 wt. %-20 wt. % of a phosphinyl mono-ester, based on the total weight of the phosphorus flame retardant;
80 wt. %-90 wt. % of a phosphinyl di-ester, based on the total weight of the phosphorus flame retardant;
less than 1 wt. % of a residue, based on the total weight of the phosphorus flame retardant; and
0.01 wt. %-1 wt. % of a basic compound, based on the total weight of the phosphorus flame retardant, the phosphorus flame retardant is produced by the method of producing a phosphinyl carboxylic ester mixture of claim 1.
